(19) United States
(12) Patent Application Publication
(10) Pub. No.: US 2020/0307305 A1
(43) Pub. Date: Oct. 1, 2020

(54) LED WHEEL LIGHT

(71) Applicant: ANTHONY BROWN, ADELANTO, CA (US)

(72) Inventor: ANTHONY BROWN, ADELANTO, CA (US)

(21) Appl. No.: 16/833,153

(22) Filed: Mar. 27, 2020

Related U.S. Application Data
(60) Provisional application No. 62/919,735, filed on Mar. 28, 2019.

(51) Int. Cl. B60B 7/00; F21V 23/04; F21V 17/00; B60Q 1/32

(52) U.S. Cl. CPC B60B 7/006; F21V 23/0435; F21Y 2115/10; B60B 7/0013; B60Q 1/326; F21V 17/002

(57) ABSTRACT

A replacement wheel cap includes a power source and LED lights illuminating a face and rim of the wheel. The power source may be batteries or a generator. The wheel cap includes simple engagement features to engage with the wheel in the same manner as the original non-illuminated cap.

### CROSS-REFERENCE TO RELATED APPLICATIONS

The present application claims the priority of U.S. Provisional Patent Application Ser. No. 62/919,735 filed Mar. 28, 2019, which application is incorporated in its entirety herein by reference.

### BACKGROUND OF THE INVENTION

The present invention relates to vehicle wheels and in particular to illuminating portions of the wheels.

U.S. Pat. No. 8,322,901 discloses a complex structure including a slip ring assembly conducting electricity from the vehicle to a wheel, and then through the wheel to LED strips on inward facing surfaces of the wheel. The device of the '901 patent is both costly and may fail if debris contaminates the slip ring.

U.S. Pat. No. 5,876,108 discloses a very thin apparatus attachable to vehicle wheels to provide a lighted display. The '108 patent does not direct illumination towards the face or rim of a wheel.

Thus, a need remains to provide simple and attractive illumination of a vehicle wheel face and rim.

### BRIEF SUMMARY OF THE INVENTION

The present invention addresses the above and other needs by providing a replacement wheel cap includes a power source and LED lights illuminating a face and rim of the wheel. The power source may be batteries or a generator. The wheel cap includes simple engagement features to engage with the wheel in the same manner as the original non-illuminated cap.

In accordance with one aspect of the invention, there is provided and LED wheel cap with a wireless control allowing a user to turn On and OFF, and change the color of the illumination.

In accordance with another aspect of the invention, there is provided an LED wheel cap with a bearing mounted offset magnet. When the wheel rotates, the magnet sweeps past a coil, generating electricity to charge a battery in the cap.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A shows a top view of an LED wheel light according to the present invention.

FIG. 1B shows a side view of an LED wheel light according to the present invention.

FIG. 2 shows an exploded view of the LED wheel light according to the present invention.

FIG. 3A shows a top view of a top cover of the LED wheel light according to the present invention.

FIG. 3B shows a side view of the top cover of the LED wheel light according to the present invention.

FIG. 4A shows a top view of a housing of the LED wheel light according to the present invention.

FIG. 4B shows a side view of the housing of the LED wheel light according to the present invention.

FIG. 4A shows a top view of a mounting portion of the LED wheel light according to the present invention.

FIG. 5B shows a side view of the mounting portion of the LED wheel light according to the present invention.

FIG. 6 is a perspective view of a center window of the LED wheel light according to the present invention.

FIG. 7A shows a top view of the center window of the LED wheel light according to the present invention.

FIG. 7B shows a side view of the center window of the LED wheel light according to the present invention.

FIG. 8 is a perspective view of an LED lens of the LED wheel light according to the present invention.

FIG. 9A shows a top view of the LED lens of the LED wheel light according to the present invention.

FIG. 9B shows a side view of the LED lens of the LED wheel light according to the present invention.

FIG. 10 shows a circuit for the LED wheel light according to the present invention.

FIG. 11 shows a battery charger for the LED wheel light according to the present invention.

FIG. 12 shows a lens having a reflector attached according to the present invention.

FIG. 13 shows a housing with a reflecting surface according to the present invention.

FIG. 14 shows a front view of the LED wheel light according to the present invention illuminating a rim and face of a wheel.

FIG. 15 shows a cross-sectional view of the LED wheel light according to the present invention illuminating a rim and face of a wheel, taken along line 15-15 of FIG. 14.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

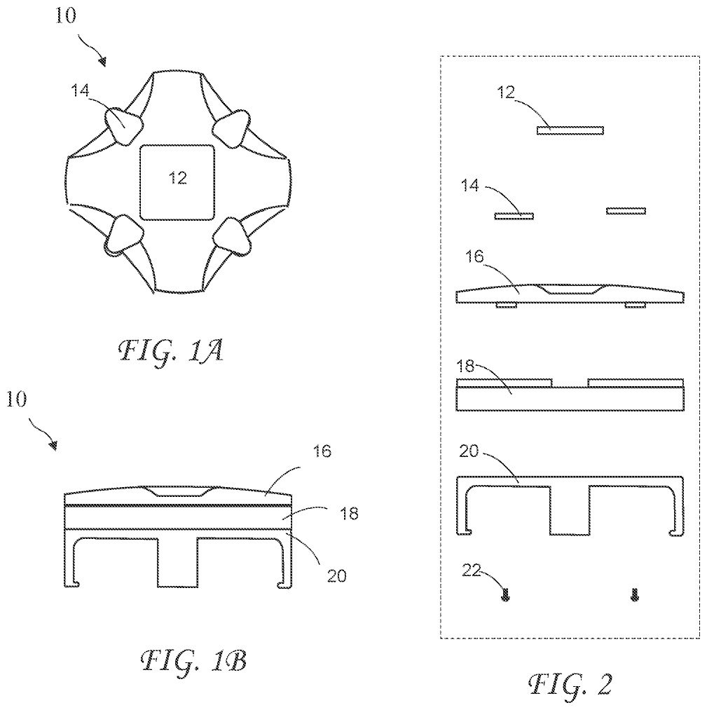

A top view of an LED wheel light 10 is shown in FIG. 1A, a side view of an LED wheel light is shown in FIG. 1B, and an exploded view of the LED wheel light 10 is shown in FIG. 2. The wheel light 10 includes a centered window 12, four lenses 14, a top cover 16, a housing 18, and a mounting portion 20. The wheel light 10 is shown assembled using four screws 22, but may be assembled in various ways.

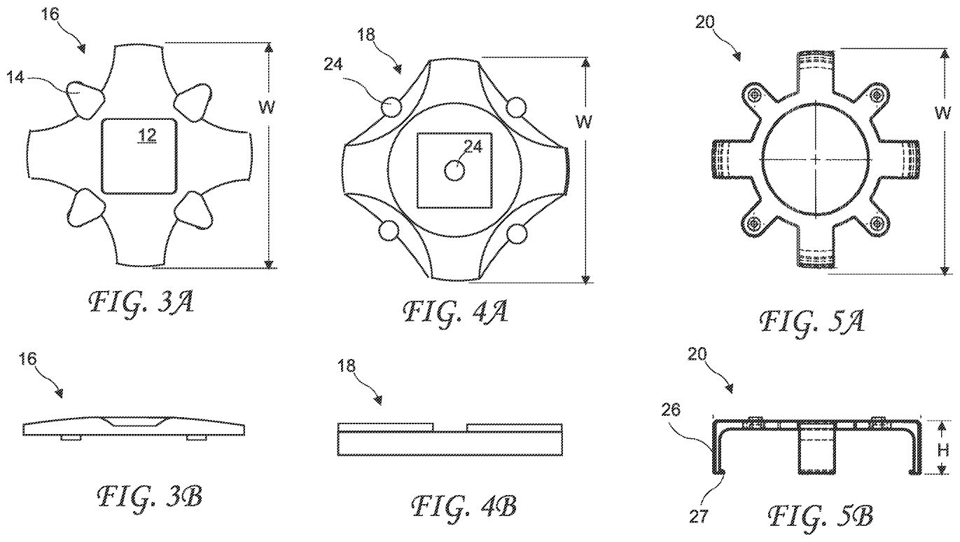

A top view of the top cover 16 is shown in FIG. 3A and a side view of the top cover 16 is shown in FIG. 3B. The four lenses 14 and window 12 are attached to the top cover 16.

A top view of a housing 18 is shown in FIG. 4A and a side view of the housing 18 is shown in FIG. 4B. LEDs 24 are preferably mounted to the housing 18, but may be attached to the cover 16 in other embodiments. At least one LED 24 resides under the window 12.

A top view of the mounting portion 20 is shown in FIG. 5A and a side view of the mounting portion 20 is shown in FIG. 5B. The mounting portion includes legs 26 which engage a wheel center, preferably in the same manner as a standard wheel cap. The legs 26 include inward reaching toes 27 to engage the wheel, but may also include other features, for example, outward reaching toes. The top cover 16, housing 18, and mounting portion 20 have a width W of between two and five inches, and is preferably about 4.5 inches. The legs 26 preferably reach between ½ and 1½ inches into a wheel, and preferably reach about one inch into the wheel.

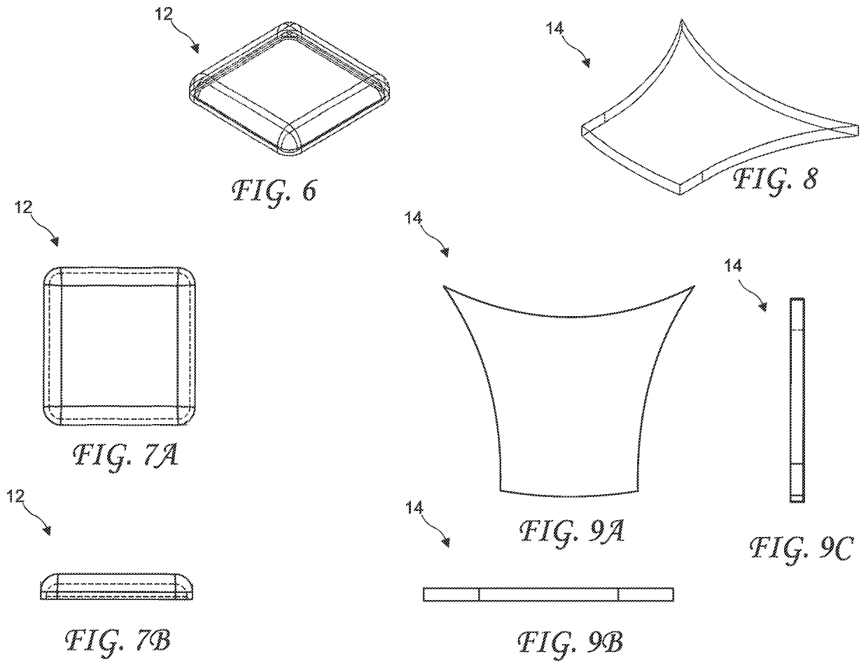

A perspective view of a clear or tinted center window 12 is shown in FIG. 6, a top view of the center window 12 is shown in FIG. 7A, and a side view of the center window 12 is shown in FIG. 7B. The center window 12 may snap into the top cover 16, or be attached by an adhesive or fastener.

A perspective view of an LED lens 14 is shown in FIG.8, a top view of the LED lens 14 is shown in FIG. 9A, a front view of the LED lens 14 is shown in FIG. 9B, and a side view of the LED lens 14 is shown in FIG. 9C. Each LED lens 14 may snap into the top cover 16, or be attached by an adhesive or fastener, or may be similarly attached to the housing 18. The LED lens 14 may be clear or tinted.

A circuit 28 for the LED wheel light 10 is shown in FIG. 10. The circuit 28 includes the LEDs 24 connected to a processor 32 by wiring 31. A battery 38 is connected by wires 37 to the processor 32 to provide power to the processor 32 to operate the processor 32 and for the LEDs 24. The processor 32 receives wireless signals 33a from a remote control 34 and may transmit wireless signals 33b to the remote control 34. The wireless signal 33a includes ON/OFF signal and may include one or more of a color signal to select a color projected by the LEDs 24, multiple colors projected by the LEDs 24, and a sequence of the LEDS providing and appearance of a moving color projected into the wheel center and rim. The wireless signal 33b may include battery 38 level and diagnostic information. A charging device 40 may be attached to the battery 38 by wires 39.

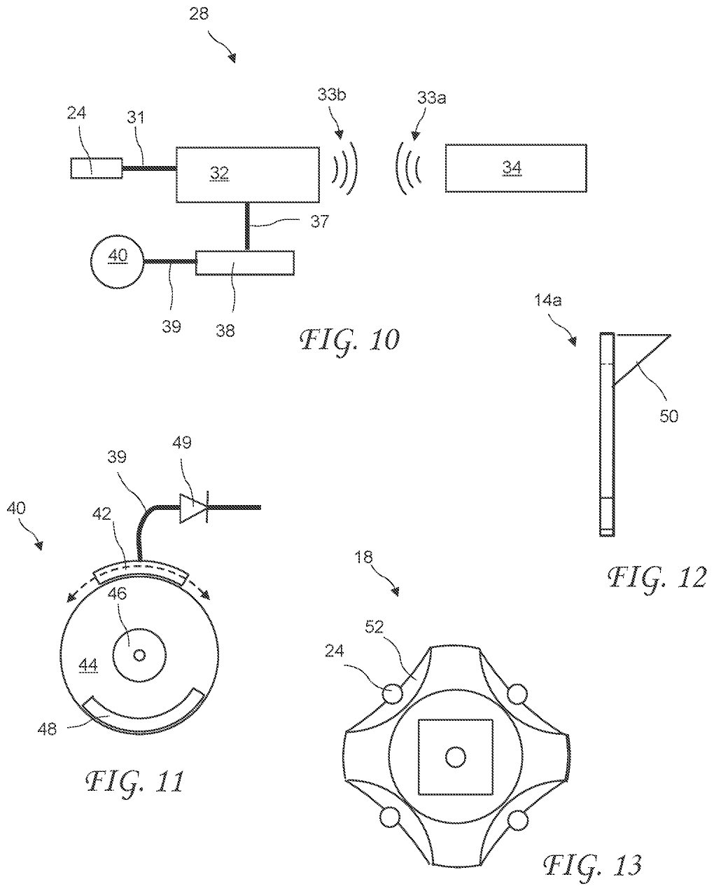

An example of a charging device 40 is shown in FIG. 11. The charging device 40 includes a magnet 48 riding on a disk 44 mounted by a bearing (or bushing) 46 to freely rotate. A coil 42 is fixed to rotate with the LED wheel light 10. When the LED wheel light 10 rotates with a vehicle wheel, the disk 44 tends to avoid rotation due to the weight of the magnet 48. As the coil 42 rotates through a magnetic field of the magnet 48, current is generated in the coil 42 to charge the battery 38. One or more Diodes 49 may be provided in the wire 39 and the diodes 49 may be arranged to rectify the current from the coil 42.

A lens 14a having a reflector 50 attached is shown in FIG. 12. The reflector 59 may have several embodiments with different shapes to vary patterns of light projected from the LEDs 24 onto the wheel center or rim. The lens 14a are preferably removable and replaceable to allow a user to customize the illumination of the wheel, for example, the lens 14a may snap into the top cover 16 or housing 18, be sandwiched between the top cover 16 and housing 18, or otherwise attachable to and detachable from the LED wheel light 10.

A reflecting surface 52 on the housing 18 is shown in FIG. 13. The reflecting surface 52 is preferably shaped to reflect light from the LEDs 24 towards the wheel center and/or rim.

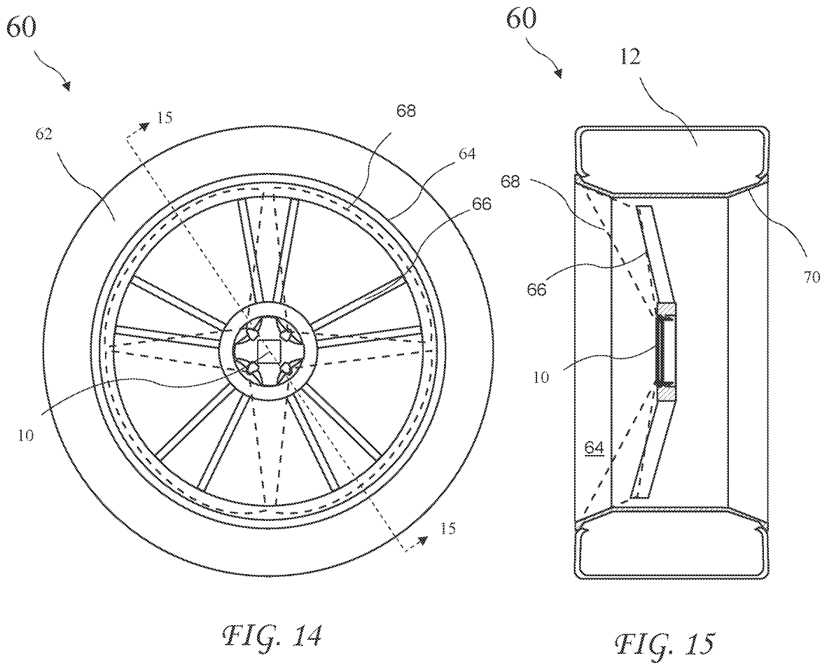

A front view of the LED wheel light 10 illuminating a rim 64 and a face 66 of a wheel 70 in FIG. 14 and a cross-sectional view of the LED wheel light 10 illuminating the rim 64 and face 66 of the wheel 70, taken along line 15-15 of FIG. 14 is shown in FIG. 15. The LED wheel light 10 projects light beams 68 against the rim 64 and face 66 of the wheel 70. The light beams 68 combining to illuminate about 360 degrees of the rim 64, illuminating substantially all of the rim 64, substantially means illuminating all of the rim 64 with at least between 60 and 80 percent of the brightest illumination of the rim 64.

While an LED wheel light is shown with four radially projecting LEDs, those skilled in the art will recognize that an LED wheel light with more or less radially projecting LEDs comes within the scope of the present invention.

While the invention herein disclosed has been described by means of specific embodiments and applications thereof, numerous modifications and variations could be made thereto by those skilled in the art without departing from the scope of the invention set forth in the claims.

I CLAIM:

1. An wheel light comprising:
a housing;
a mounting portion attached to the housing configured to attach to a wheel center;
a circuit residing in the housing;
lights electrically connected to receive power from the circuit and directing light beams radially out towards a rim and face of the wheel.

2. The wheel light of claim 1, wherein the lights comprise between 3 and 6 lights.

3. The wheel light of claim 1, wherein the lights are LEDs.

4. The wheel light of claim 1, wherein the mounting portion includes attaching features to attach to the wheel center as an original cap attaches to the wheel center.

5. The wheel light of claim 1, wherein the circuit is wirelessly controlled by a remote control.

6. The wheel light of claim 5, wherein the remote control can turn the lights ON and OFF.

7. The wheel light of claim 7, wherein the remote control can control a color of the lights.

8. The wheel light of claim 7, wherein the remote control can control a sequence of the lights to create an appearance of motion on the face and rim of the wheel.

9. The wheel light of claim 5, wherein the circuit transmits remaining battery power level to the remote control.

10. The wheel light of claim 1, further including a charger electrically connected to a battery powering the circuit.

11. The wheel light of claim 10, wherein the charger includes a rotatably attached magnet radially offset from a center of rotation and cooperating with a coil to generate current to charge the battery.

12. The wheel light of claim 1, further including lenses covering the lights.

13. The wheel light of claim 12, wherein;
the lenses include a reflector and are removable and replaceable; and
the lens may be selected to include a reflector providing a desired light beam.
